(19) United States
(12) Patent Application Publication
(10) Pub. No.: US 2013/0117493 A1
(43) Pub. Date: May 9, 2013

(54) Reliable Memory Mapping In A Computing System

(71) Applicants: Nathan C. Skalsky, Durham, NC (US); Ivan R. Zapata, Cary, NC (US)

(72) Inventors: Nathan C. Skalsky, Durham, NC (US); Ivan R. Zapata, Cary, NC (US)

(73) Assignee: International Business Machines Corporation, Armonk, NY (US)

(21) Appl. No.: 13/289,311

(22) Filed: Nov. 4, 2011

(51) Int. Cl. G06F 12/06

(52) U.S. Cl. 711/5; 711/E12.081

(57) ABSTRACT

Methods, apparatus, and products for reliable memory mapping in a computing system, the computing system including a plurality of memory modules, including: determining, by a channel mapping module, a reliability rating for each of a plurality of memory controller address ranges; mapping, by the channel mapping module, critical system-level memory addresses to the most reliable memory controller address ranges; and directing, by the channel mapping module, memory accesses addressed to a critical system-level memory address to the most reliable memory controller address ranges.

### BACKGROUND OF THE INVENTION

1. Field of the Invention

The field of the invention is data processing, or, more specifically, methods, apparatus, and products for reliable memory mapping in a computing system.

2. Description of Related Art

Modern computing systems typically include memory modules that are used to store data in the computing system. Such memory modules are becoming faster, offer increasing amounts of storage, and operate at lower operating voltages than their predecessors. As the capacity, density, frequency goes up and operating voltages go down there has emerged a wider range of reliability amongst memory modules. In modern memory architectures, overall system reliability is disproportionately affected by the reliability of the “first” memory module in the computing system as this memory module is typically utilized by critical system-level resources such as the operating system.

### SUMMARY OF THE INVENTION

Methods, apparatus, and products for reliable memory mapping in a computing system, the computing system including a plurality of memory modules, including: determining, by a channel mapping module, a reliability rating for each of a plurality of memory controller address ranges; mapping, by the channel mapping module, critical system-level memory addresses to the most reliable memory controller address ranges; and directing, by the channel mapping module, memory accesses addressed to a critical system-level memory address to the most reliable memory controller address ranges.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of automated computing machinery comprising an example computing system useful in reliable memory mapping according to embodiments of the present invention.

FIG. 2 sets forth a flow chart illustrating an example method for reliable memory mapping in a computing system according to embodiments of the present invention.

FIG. 3 sets forth a flow chart illustrating a further example method for reliable memory mapping in a computing system according to embodiments of the present invention.

### DETAILED DESCRIPTION OF EXAMPLE EMBODIMENTS

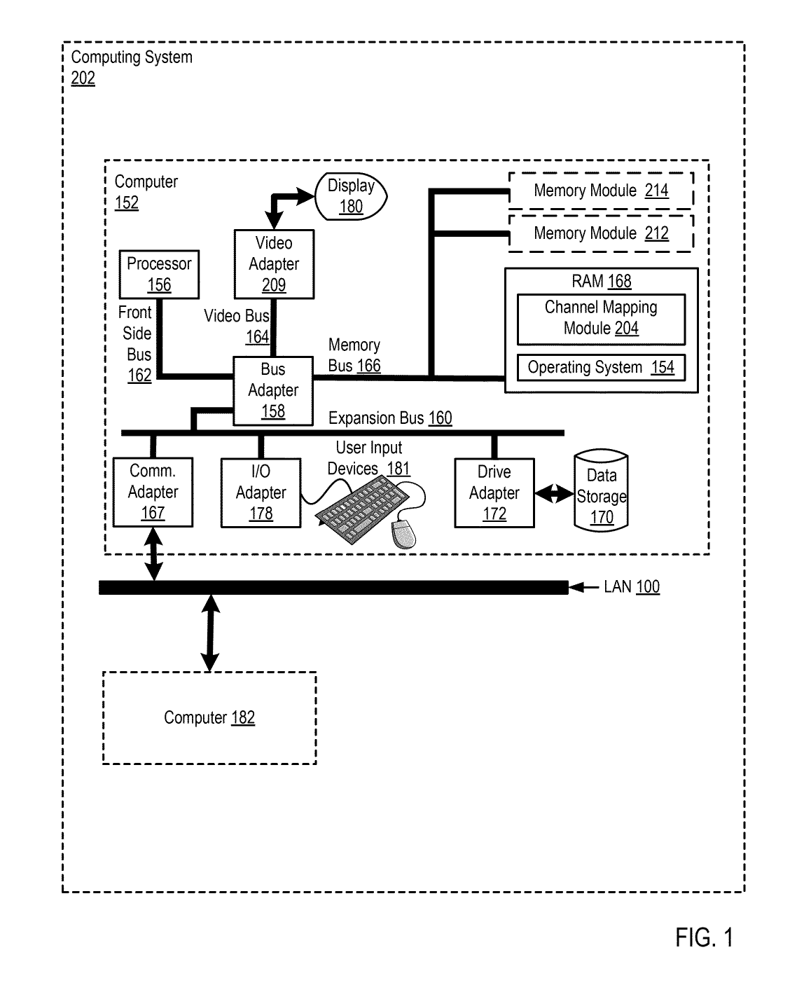

Example methods, apparatus, and products for reliable memory mapping in a computing system in accordance with the present invention are described with reference to the accompanying drawings, beginning with FIG. 1. FIG. 1 sets forth a block diagram of automated computing machinery comprising an example computing system (202) useful in reliable memory mapping according to embodiments of the present invention. The computing system (202) of FIG. 1 includes one or more memory modules (212, 214). In the example of FIG. 1, each memory module (212, 214) is a computer memory component. Examples of memory modules (212, 214) include dual in-line memory modules (‘DIMMs’), single in-line memory modules (‘SIMMs’), and so on. The computing system (202) of FIG. 1 also includes an example computer (152). The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a channel mapping module (204), a module of computer program instructions for automated computing machinery for mapping physical memory controller address ranges to logical memory controller address ranges. Although the channel mapping module (204) of FIG. 1 is depicted as being stored in RAM (168), the channel mapping module (204) may also be embodied, for example, as computer program instructions executing on computer hardware such as a memory controller.

The channel mapping module (204) of FIG. 1 is configured to determine a reliability rating for each of a plurality of memory controller address ranges. A memory controller address range represents a segment of computer memory that can be accessed by a memory controller at memory addresses within the memory controller address range. Each memory controller address range may represent, for example, the entire memory provided by a particular memory module (212, 214), a portion of the memory provided by a particular memory module (212, 214), or memory provided by more than one memory module (212). In the example of FIG. 1, determining a reliability rating for each of a plurality of memory controller address ranges may be carried out, for example, by counting the number of memory access errors that occurs within a memory controller address range. Memory access errors may include a failed attempt to write data to a particular memory address, a failed attempt to read data from a particular memory access, and so on. By counting the number of memory access errors that occurs within a memory controller address range, the channel mapping module (204) can determine how reliable a segment of computer memory is that is addressable by the memory controller address range. The reliability rating may be expressed, for example, as a percentage of the memory access operations that resulted in a memory access error, as a broader characterization such as ‘reliable,’ ‘semi-reliable,’ or ‘unreliable’ based on the percentage of the memory access operations that resulted in a memory access error, and so on.

The channel mapping module (204) of FIG. 1 is also configured to map critical system-level memory addresses to the most reliable memory controller address ranges. Critical system-level memory addresses represent a portion of a computing system's (202) computer memory that is used by critical system-level entities such as an operating system (154). For example, the operating system (154) may utilize computer memory to store information about different processes supported by the operating system (154), data related to those processes, and a variety of additional information. Because this information is so critical to the operation of the entire computing system (202), storing such information in the most reliable segments of computer memory available in the computing system (202) can increase system stability.

The channel mapping module (204) of FIG. 1 is also configured to direct memory accesses addressed to a critical system-level memory address to the most reliable memory controller address ranges. The channel mapping module (204) may direct memory accesses addressed to a critical system-level memory address to the most reliable memory controller address ranges, for example, by looking up the address contained in the memory access operation in a table that associates addresses used by critical system-level with addresses that correspond to the most reliable memory modules. In such a way, the most reliable range of address is used to store the critical system-level information.

In the example of FIG. 1, the channel mapping module (204) includes the term ‘channel’ as an acknowledgment that memory access errors may occur because of problems within the entire channel—not just problems within the memory module itself. For example, a memory access directed to a particular address may result in an error because of problems with the memory bus over which an instruction is sent, because of problems with the connector or socket that connects a memory module to a motherboard, and so on. As such, the reliability of a particular range of addresses may be impacted by all of the components in the channel that an instruction must traverse in order for a memory access operation to be carried out.

Also stored in RAM (168) is an operating system (154). Operating systems useful reliable memory mapping in a computing system (202) according to embodiments of the present invention include UNIX™, Linux™, Microsoft XP™, AIX™, IBM's i5/OS™, and others as will occur to those of skill in the art. The operating system (154) and channel mapping module (204) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for reliable memory mapping in a computing system (202) according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for reliable memory mapping in a computing system (202) according to embodiments of the present invention include modems for wired dial-up communications, Ethernet (IEEE 802.3) adapters for wired data communications network communications, and 802.11 adapters for wireless data communications network communications.

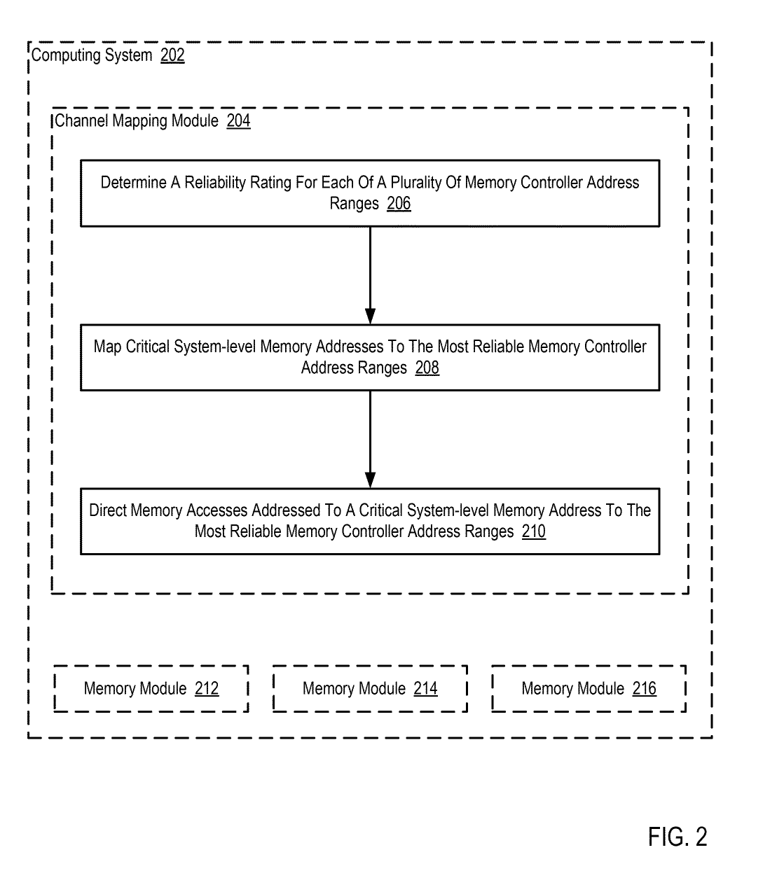

For further explanation, FIG. 2 sets forth a flow chart illustrating an example method for reliable memory mapping in a computing system (202) according to embodiments of the present invention. The computing system (202) of FIG. 2 includes one or more memory modules (212, 214, 216). In the example method of FIG. 2, each memory module (212, 214, 216) is a computer memory component. Examples of memory modules (212, 214, 216) include DIMMs, SIMMs, and so on.

The example method of FIG. 2 includes determining (206), by a channel mapping module (204), a reliability rating for each of a plurality of memory controller address ranges. In the example method of FIG. 2, a channel mapping module (204) is a module of automated computing machinery for mapping physical memory controller address ranges to logical memory controller address ranges. The channel mapping module (204) may be embodied, for example, as computer program instructions executing on computer hardware such as a memory controller.

The channel mapping module (204) of FIG. 2 is configured to determine (206) a reliability rating for each of a plurality of memory controller address ranges. In the example method of FIG. 2, a memory controller address range represents a segment of computer memory that can be accessed by a memory controller at memory addresses within the memory controller address range. Each memory controller address range may represent, for example, the entire memory provided by a particular memory module (212, 214, 216), a portion of the memory provided by a particular memory module (212, 214, 216), or memory provided by more than one memory module (212, 214, 216).

In the example method of FIG. 2, determining (206) a reliability rating for each of a plurality of memory controller address ranges may be carried out, for example, by counting the number of memory access errors that occurs within a memory controller address range. Memory access errors may include a failed attempt to write data to a particular memory address, a failed attempt to read data from a particular memory access, and so on. By counting the number of memory access errors that occurs within a memory controller address range, the channel mapping module (204) can determine how reliable a segment of computer memory is that is addressable by the memory controller address range. The reliability rating may be expressed, for example, as a percentage of the memory access operations that resulted in a memory access error, as a broader characterization such as ‘reliable,’ ‘semi-reliable,’ or ‘unreliable’ based on the percentage of the memory access operations that resulted in a memory access error, and so on.

The example method of FIG. 2 also includes mapping (208), by the channel mapping module (204), critical system-level memory addresses to the most reliable memory controller address ranges. In the example method of FIG. 2, critical system-level memory addresses represent a portion of a computing system's (202) computer memory that is used by critical system-level entities such as an operating system. For example, the operating system may utilize computer memory to store information about different processes supported by the operating system, data related to those processes, and a variety of additional information. Because this information is so critical to the operation of the entire computing system (202), storing such information in the most reliable segments of computer memory available in the computing system (202) can increase system stability.

In the example method of FIG. 2, mapping (208) critical system-level memory addresses to the most reliable memory controller address ranges may be carried out, for example, through the use of a data structure such as a table. Such a table is depicted below:

TABLE 1
Channel Mapped Table

| Physical Address Range | Logical Address Range |
|---|---|
| 0-1000 | 1001-2000 |
| 1001-2000 | 0-1000 |
| 2001-3000 | 2001-3000 |

In the channel mapped table above, each physical address range is mapped to a logical address range. In this example, assume that the first range of physical addresses (addresses 0-1000) were deemed to be the least reliable segment of memory, the second range of physical addresses (addresses 1001-2000) were deemed to be the most reliable segment of memory, and the third range of physical addresses (addresses 2001-3000) were deemed to be neither the least reliable segment of memory nor the most reliable segment of memory. In this example, also assume that the critical system-level entities naturally use the first range of physical addresses (addresses 0-1000) to store critical system-level information. In such an example, the channel mapped table above allows the memory controller to use the second range of physical addresses (addresses 1001-2000) that were determined to be the most reliable range of addresses to store critical system-level information.

The example method of FIG. 2 also includes directing (210), by the channel mapping module (204), memory accesses addressed to a critical system-level memory address to the most reliable memory controller address ranges. In the example of FIG. 2, the channel mapping module (204) may direct (210) memory accesses addressed to a critical system-level memory address to the most reliable memory controller address ranges by looking up the address contained in the memory access operation in the channel mapped table described above. The channel mapped table described above was generated in an example in which the critical system-level entities naturally use the first range of physical addresses (addresses 0-1000) to store critical system-level information and the second range of physical addresses (addresses 1001-2000) were determined to be the most reliable range of addresses. In such an example, when the memory controller receives a memory access operation from the critical system-level entity, addressed to an address in the first range of physical addresses, the memory controller may instead address the memory access operation to an address specified by corresponding the logical address range. In such a way, the most reliable range of address is used to store the critical system-level information.

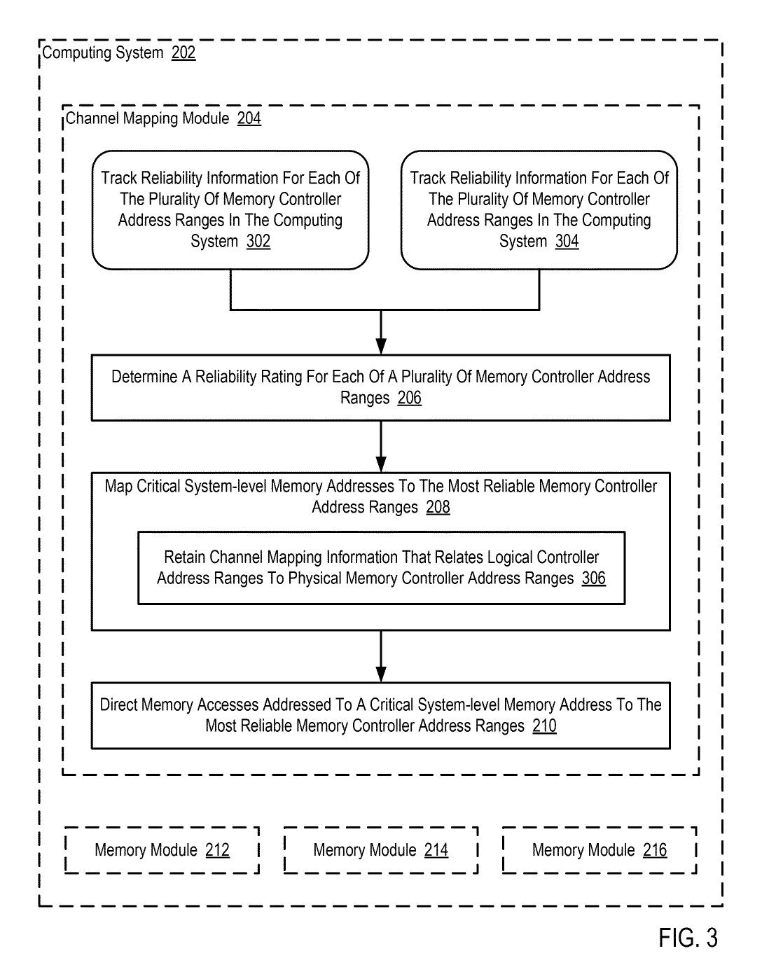

For further explanation, FIG. 3 sets forth a flow chart illustrating a further example method for memory mapping in a computing system (202) that includes a plurality of memory modules (212, 214, 216) according to embodiments of the present invention. The example method of FIG. 3 is similar to the example method of FIG. 2 as it also includes determining (206) a reliability rating for each of a plurality of memory controller address ranges, mapping (208) critical system-level memory addresses to the most reliable memory controller address ranges, and directing (210) memory accesses addressed to a critical system-level memory address to the most reliable memory controller address ranges.

The example method of FIG. 3 also includes tracking (302), by the channel mapping module (204) during a testing phase, reliability information for each of the plurality of memory controller address ranges in the computing system (202). In the example method of FIG. 3, the testing phase represents a series of memory access operations that are executed for the purpose of gathering reliability ratings for one or more memory controller address ranges. The testing phase may include performing write operations and read operations at each address in the address range, performing write operations and read operations at a subset of the addresses in the address range, and so on. Tracking (302) reliability information for each of the plurality of memory controller address ranges in the computing system (202) during a testing phase may therefore include retaining statistical information describing the percentage of memory accesses that resulted in a memory access error.

The example method of FIG. 3 also includes tracking (304), by the channel mapping module (204) during run-time of the computing system (202), reliability information for each of the plurality of memory controller address ranges in the computing system (202). In the example method of FIG. 3, the run-time of the computing system (202) represents standard operations of the computing system (202) in which memory access operations are not executed for the purpose of gathering reliability ratings for one or more memory controller address ranges. Instead, memory access operations are executed as part of the computing system's (202) standard operation. Tracking (304) reliability information for each of the plurality of memory controller address ranges in the computing system (202) during run-time may therefore include retaining statistical information describing the percentage of memory accesses that resulted in a memory access error.

In the example method of FIG. 3, mapping (208) the critical system-level memory addresses to the most reliable memory controller address ranges includes retaining (306), by the channel mapping module (204), channel mapping information that relates logical controller address ranges to physical memory controller address ranges. Retaining (306) channel mapping information that relates logical controller address ranges to physical memory controller address ranges may be carried out by storing such information in a channel mapped table as described above. Alternatively, retaining (306) channel mapping information that relates logical controller address ranges to physical memory controller address ranges may be carried out by storing such information in a variety of other data structures such as a linked list, array, and so on.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of reliable memory mapping in a computing system, the computing system including a plurality of memory modules, the method comprising:
determining, by a channel mapping module, a reliability rating for each of a plurality of memory controller address ranges;
mapping, by the channel mapping module, critical system-level memory addresses to the most reliable memory controller address ranges; and
directing, by the channel mapping module, memory accesses addressed to a critical system-level memory address to the most reliable memory controller address ranges.

2. The method of claim 1 further comprising tracking, by the channel mapping module during a testing phase, reliability information for each of the plurality of memory controller address ranges in the computing system.

3. The method of claim 1 further comprising tracking, by the channel mapping module during run-time of the computing system, reliability information for each of the plurality of memory controller address ranges in the computing system.

4. The method of claim 1 wherein the critical system-level memory addresses include address space utilized by the operating system.

5. The method of claim 1 wherein the memory modules are dual in-line memory modules (‘DIMMs’).

6. The method of claim 1 wherein mapping, by the channel mapping module, the critical system-level memory addresses to the most reliable memory controller address ranges further comprises retaining, by the channel mapping module, channel mapping information that relates logical controller address ranges to physical memory controller address ranges.

7. An apparatus for reliable memory mapping in a computing system, the computing system including a plurality of memory modules, the apparatus comprising a computer processor, a computer memory operatively coupled to the computer processor, the computer memory having disposed within it computer program instructions that, when executed, carry out the steps of:
determining, by a channel mapping module, a reliability rating for each of a plurality of memory controller address ranges;
mapping, by the channel mapping module, critical system-level memory addresses to the most reliable memory controller address ranges; and
directing, by the channel mapping module, memory accesses addressed to a critical system-level memory address to the most reliable memory controller address ranges.

8. The apparatus of claim 7 further comprising computer program instructions that, when executed, carry out the step of tracking, by the channel mapping module during a testing phase, reliability information for each of the plurality of memory controller address ranges in the computing system.

9. The apparatus of claim 7 further comprising computer program instructions that, when executed, carry out the step of tracking, by the channel mapping module during run-time of the computing system, reliability information for each of the plurality of memory controller address ranges in the computing system.

10. The apparatus of claim 7 wherein the critical system-level memory addresses include address space utilized by the operating system.

11. The apparatus of claim 7 wherein the memory modules are dual in-line memory modules (‘DIMMs’).

12. The apparatus of claim 7 wherein mapping, by the channel mapping module, the critical system-level memory addresses to the most reliable memory controller address ranges further comprises retaining, by the channel mapping module, channel mapping information that relates logical controller address ranges to physical memory controller address ranges.

13. A computer program product for reliable memory mapping in a computing system, the computing system including a plurality of memory modules, the computer program product disposed upon a computer readable medium, the computer program product comprising computer program instructions that, when executed, cause a computer to carry out the steps of:
determining, by a channel mapping module, a reliability rating for each of a plurality of memory controller address ranges;
mapping, by the channel mapping module, critical system-level memory addresses to the most reliable memory controller address ranges; and
directing, by the channel mapping module, memory accesses addressed to a critical system-level memory address to the most reliable memory controller address ranges.

14. The computer program product of claim 13 further comprising computer program instructions that, when executed, cause a computer to carry out the step of tracking, by the channel mapping module during a testing phase, reliability information for each of the plurality of memory controller address ranges in the computing system.

15. The computer program product of claim 13 further comprising computer program instructions that, when executed, cause a computer to carry out the step of tracking, by the channel mapping module during run-time of the computing system, reliability information for each of the plurality of memory controller address ranges in the computing system.

16. The computer program product of claim 13 wherein the critical system-level memory addresses include address space utilized by the operating system.

17. The computer program product of claim 13 wherein the memory modules are dual in-line memory modules (‘DIMMs’).

18. The computer program product of claim 13 wherein mapping, by the channel mapping module, the critical system-level memory addresses to the most reliable memory controller address ranges further comprises retaining, by the channel mapping module, channel mapping information that relates logical controller address ranges to physical memory controller address ranges.

19. The computer program product of claim 13 wherein the computer readable medium further comprises a computer readable signal medium.

20. The computer program product of claim 13 wherein the computer readable medium further comprises a computer readable storage medium.
